(19) United States
(12) Patent Application Publication
(10) Pub. No.: US 2026/0326437 A1
(43) Pub. Date: Oct. 22, 2026

(54) LIQUID EJECTION HEAD AND RECORDING DEVICE

(71) Applicant: KYOCERA Corporation, Kyoto (JP)

(72) Inventor: Fumito NAKAMOTO, Kirishima-shi, Kagoshima (JP)

(21) Appl. No.: 19/107,548

(22) PCT Filed: Aug. 28, 2023
(86) PCT No.: PCT/JP2023/031013

§ 371 Date: Feb. 27, 2025

(30) Foreign Application Priority Data
Aug. 29, 2022 (JP) 2022-136359

(51) Int. Cl. B41J 2/14; B41J 2/16

(52) U.S. Cl. CPC B41J 2/14233; B41J 2/161; B41J 2/1623; B41J 2002/14266; B41J 2202/19

(57) ABSTRACT

A liquid ejection head includes a channel member, a pressurizing portion, a flexible substrate, and a reservoir. The channel member has an ejection hole through which a liquid is ejected. The pressurizing portion is located on the channel member. The flexible substrate is electrically connected to the pressurizing portion. The reservoir has a slit through which the flexible substrate is inserted, and a flow path supplies liquid to the channel member. A protective sheet is located between an inner wall surface of the slit and the flexible substrate.

### CROSS-REFERENCE TO RELATED APPLICATIONS

This application is a national stage application of International Application No. PCT/JP 2023/031013, filed on Aug. 28, 2023, which designates the United States, incorporated herein by reference, and which claims the benefit of priority from Japanese Patent Application No. 2022-136359, filed on Aug. 29, 2022.

### TECHNICAL FIELD

Embodiments of the disclosure relate to a liquid ejection head and a recording device.

### BACKGROUND OF INVENTION

Inkjet printers and inkjet plotters using inkjet recording method are known as printing devices. Such inkjet printing devices are equipped with a liquid ejection head for ejecting liquid.

The liquid ejection head includes a flexible substrate that is connected to a pressurizing portion on a channel member for ejecting liquid. The flexible substrate is inserted through a slit in a reservoir supplying liquid to the channel member and extends above the reservoir from the slit.

CITATION LIST

### Patent Literature

Patent Document 1: JP 2010-227759 A

### SUMMARY

A liquid ejection head according to an embodiment includes a channel member, a pressurizing portion, a flexible substrate, a reservoir, and a protective sheet. The channel member has an ejection hole through which a liquid is ejected. The pressurizing portion is located on the channel member. The flexible substrate is electrically connected to the pressurizing portion. The reservoir has a slit through which the flexible substrate is inserted, and supplies liquid to the channel member. A protective sheet is located between an inner wall surface of the slit, which faces the flexible substrate in the width direction, and the flexible substrate.

### BRIEF DESCRIPTION OF THE DRAWINGS

FIG. 1 is a schematic front view of a printer according to an embodiment.

FIG. 2 is a schematic plan view of a printer according to an embodiment.

FIG. 3 is an exploded perspective view illustrating a schematic configuration of a liquid ejection head according to an embodiment.

FIG. 4 is a perspective view illustrating a configuration of a main portion of a liquid ejection head according to an embodiment.

FIG. 5 is an enlarged plan view of a head body according to an embodiment.

FIG. 6 is an enlarged view of a region surrounded by a dashed line illustrated in FIG. 5.

FIG. 7 is a cross-sectional view along the line VII-VII illustrated in FIG. 5.

FIG. 8 is an enlarged cross-sectional view along the line VIII-VIII illustrated in FIG. 4.

FIG. 9 is a side view of a protective sheet viewed from the negative X-axis direction.

FIG. 10 is an explanatory view for describing an example of a method of bonding the protective sheet.

### DESCRIPTION OF EMBODIMENTS

Hereafter, embodiments of a liquid ejection head and a recording device disclosed in the present application will be described below with reference to the attached drawings. The present disclosure is not limited by the following embodiments. In addition, note that the drawings are schematic, and the relationship between the dimensions of each element and the ratio of each element may differ from reality. Furthermore, even between the drawings, there may be parts in which the relationships between the dimensions and the ratio of each element differ.

In the following embodiments, expressions such as “constant”, “orthogonal”, “perpendicular”, and “parallel” may be used, but these expressions need not mean exactly “constant”, “orthogonal”, “perpendicular”, and “parallel”. In other words, it is assumed that the above expressions allow for deviations in manufacturing accuracy, installation accuracy, or the like.

Embodiments can be appropriately combined within a range so as not to contradict each other in terms of processing content. In the following embodiments, the same portions are denoted by the same reference signs, and redundant descriptions are omitted.

### Configuration of Printer

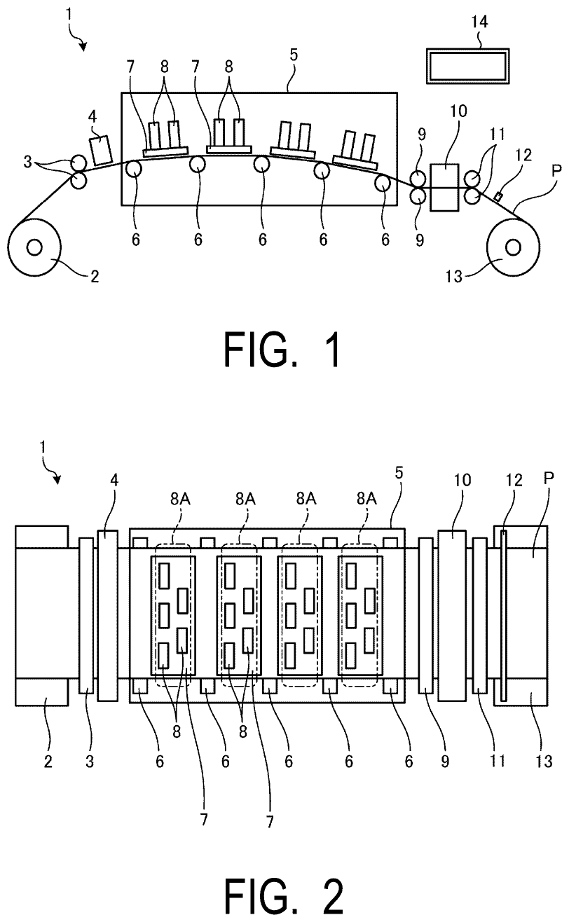

First, with reference to FIGS. 1 and 2, an outline of a printer 1 as an example of a recording device according to an embodiment will be described. FIG. 1 is a schematic front view of the printer 1 according to an embodiment. FIG. 2 is a schematic plan view of the printer 1 according to an embodiment. The printer 1 according to an embodiment is, for example, a color inkjet printer.

As illustrated in FIG. 1, the printer 1 includes a paper feed roller 2, a guide roller 3, an applicator 4, a head case 5, a plurality of transport rollers 6, a plurality of frames 7, a plurality of liquid ejection heads 8, a transport roller 9, a dryer 10, a transport roller 11, a sensor unit 12, and a collection roller 13.

Furthermore, the printer 1 includes a controller 14 for controlling each portion of the printer 1. The controller 14 controls the operation of the paper feed roller 2, the guide roller 3, the applicator 4, the head case 5, the plurality of transport rollers 6, the plurality of frames 7, the plurality of liquid ejection heads 8, the transport roller 9, the dryer 10, the transport roller 11, the sensor unit 12, and the collection roller 13.

The printer 1 records images and characters on a printing paper P by causing droplets to land on the printing paper P. The printing paper P is an example of a recording medium.

The printing paper P is rolled around the paper feed roller 2 before use. The printer 1 transports the printing paper P from the paper feed roller 2 to the inside of the head case 5 via the guide roller 3 and the applicator 4.

The applicator 4 uniformly applies a coating agent to the printing paper P. This can apply surface treatment to the printing paper P, thereby improving the printing quality of the printer 1.

The head case 5 accommodates the plurality of transport rollers 6, the plurality of frames 7, and the plurality of liquid ejection heads 8. The inside of the head case 5 forms a space isolated from the outside except for a part connected to the outside such as the part where the printing paper P enters and leaves.

In the internal space of the head case 5, at least one of the controlling factors such as temperature, humidity, and air pressure is controlled by the controller 14 as required. The transport roller 6 transports the printing paper P to the vicinity of the liquid ejection head 8 inside the head case 5.

The frame 7 is a rectangular flat plate and is located close to and above the printing paper P conveyed by the transport roller 6. As illustrated in FIG. 2, the frame 7 is located so that the longitudinal direction is perpendicular to the conveyance direction of the printing paper P. A plurality of (e.g., four) frames 7 are located inside the head case 5 at predetermined intervals along the conveyance direction of the printing paper P.

Liquid, for example, ink, is supplied from a liquid tank (not illustrated) to the liquid ejection head 8. The liquid ejection head 8 ejects the liquid supplied from the liquid tank.

The controller 14 controls the liquid ejection head 8 based on data such as images and characters, ejecting the liquid toward the printing paper P. The distance between the liquid ejection head 8 and the printing paper P is, for example, about 0.5 to 20 mm.

The liquid ejection head 8 is fixed to the frame 7. The liquid ejection head 8 is located so that its longitudinal direction is orthogonal to the conveyance direction of the printing paper P.

That is, the printer 1 according to an embodiment is a so-called line printer in which the liquid ejection head 8 is fixed inside the printer 1. The printer 1 according to an embodiment is not limited to a line printer but may be a so-called serial printer.

The serial printer is a type of printer that performs alternately: the operation of recording while moving the liquid ejection head 8 in a direction intersecting with the conveyance direction of the printing paper P, for example, by reciprocating in a direction substantially orthogonal to the conveyance direction of the printing paper P; and the transport of the printing paper P.

As illustrated in FIG. 2, a plurality of (e.g., five) liquid ejection heads 8 are fixed in one frame 7. FIG. 2 illustrates an example in which two liquid ejection heads 8 are located in front of the conveyance direction of the printing paper P and three liquid ejection heads 8 are located in the rear such that the centers of the liquid ejection heads 8 do not overlap with each other in the conveyance direction of the printing paper P.

A head group 8A is composed of a plurality of liquid ejection heads 8 located in one frame 7. Four head groups 8A are located along the conveyance direction of the printing paper P. The same color ink is supplied to the liquid ejection heads 8 belonging to the same head group 8A. Thus, the printer 1 can print with four colors of ink using the four head groups 8A.

The colors of the ink ejected from each head group 8A are, for example, magenta (M), yellow (Y), cyan (C), and black (K). The controller 14 can print a color image on the printing paper P by controlling each head group 8A and ejecting inks of a plurality of colors to the printing paper P.

In order to treat the surface of the printing paper P, a coating agent may be ejected from the liquid ejection head 8 to the printing paper P.

The number of liquid ejection heads 8 included in one head group 8A and the number of head groups 8A mounted on the printer 1 can be appropriately changed depending on the printing target and printing conditions. For example, when the color to be printed on the printing paper P is a single color and the range printable by one liquid ejection head 8 is to be printed, the number of liquid ejection heads 8 mounted on the printer 1 may be one.

The printing paper P that has been printed inside the head case 5 is conveyed outside the head case 5 by the transport roller 9 and passes through the dryer 10. The dryer 10 dries the printing paper P that has been printed. The printing paper P dried by the dryer 10 is conveyed by the transport roller 11 and collected by the collection roller 13.

The printer 1, by drying the printing paper P with the dryer 10, can reduce the adhesion between overlapping pieces of printing paper P wound up on the collection roller 13 and the rubbing of undried liquid.

The sensor unit 12 is composed of a position sensor, a speed sensor, a temperature sensor, or the like. The controller 14 determines the state of each portion of the printer 1 based on the information from the sensor unit 12, and can control each portion of the printer 1.

The printer 1 described, as one case, so far uses the printing paper P as the printing object (i.e., a recording medium). However, the printing object in the printer 1 is not limited to the printing paper P, and a rolled cloth or the like may be used as the printing object.

In addition, instead of conveying the printing paper P directly, the printer 1 may convey the printing paper P placed on a conveyance belt. By using the conveyance belt, the printer 1 can print on sheet paper, cut cloth, wood, tile, or the like.

In addition, the printer 1 may print wiring patterns of electronic equipment by ejecting liquid containing conductive particles from the liquid ejection head 8.

In addition, the printer 1 may produce chemicals by ejecting a predetermined amount of chemical agents or liquid containing chemical agents from the liquid ejection head 8 toward a reaction vessel, or the like.

The printer 1 may also include a cleaning portion for cleaning the liquid ejection head 8. The cleaning portion cleans the liquid ejection head 8 by, for example, wiping or capping.

The wiping process is a process for removing the liquid adhering to the liquid ejection head 8 by, for example, using a flexible wiper to wipe the surface of the portion in which the liquid is to be ejected.

The capping process is performed, for example, as follows. First, a cap is applied so as to cover the portion where the liquid is to be ejected, for example, the second surface 21b (see FIG. 7) of a channel member 21, which is called capping. Thus, a substantially sealed space is formed between the second surface 21b and the cap.

Next, the ejection of the liquid is repeated within such a sealed space. This can remove the liquid or foreign matter that has a viscosity higher than the standard condition and is stuck in an ejection hole 163 (see FIG. 7).

### Configuration of Liquid Ejection Head

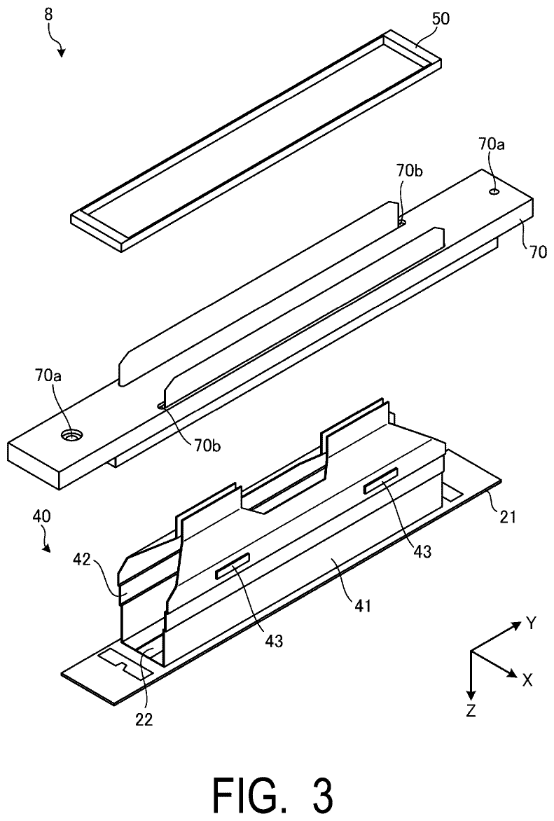

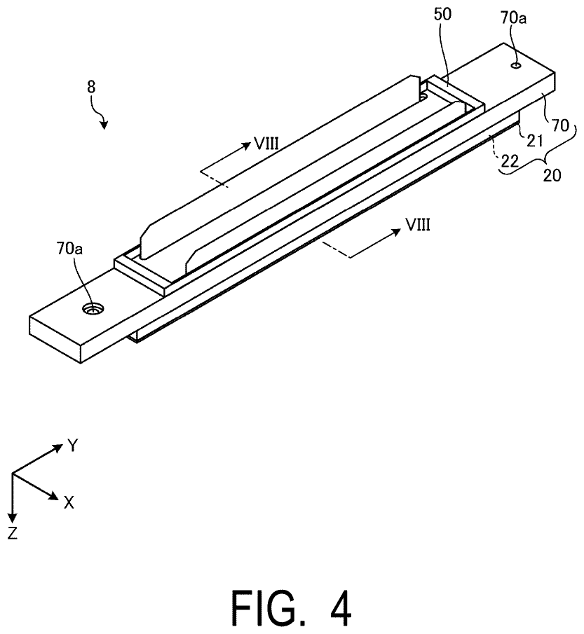

Next, the configuration of the liquid ejection head 8 according to an embodiment will be described with reference to FIGS. 3 and 4. FIG. 3 is an exploded perspective view illustrating an overall configuration of the liquid ejection head 8 according to an embodiment. FIG. 4 is a perspective view illustrating a configuration of a main portion of the liquid ejection head 8 according to an embodiment.

The liquid ejection head 8 includes a head body 20, a wiring portion 40, and a support member 50. The head body 20 includes the channel member 21, a piezoelectric actuator substrate 22, and a reservoir 70. The wiring portion 40 includes flexible substrates 41 and 42, and a drive IC 43.

FIGS. 3 and 4 illustrate a three-dimensional rectangular coordinate system including the Z-axis in which the vertical downward direction is positive and the vertical upward direction is negative. Such a rectangular coordinate system may also be illustrated in other drawings used in the following description. In the following description, for convenience, the direction in which the channel member 21 of the head body 20 is provided in the liquid ejection head 8, i.e., the positive Z-axis direction side, may be referred to as “lower” and the direction in which the reservoir 70 is provided relative to the channel member 21, i.e., the negative Z-axis direction side, may be referred to as “upper”. In FIGS. 3 and 4, the shape of each member may be simplified.

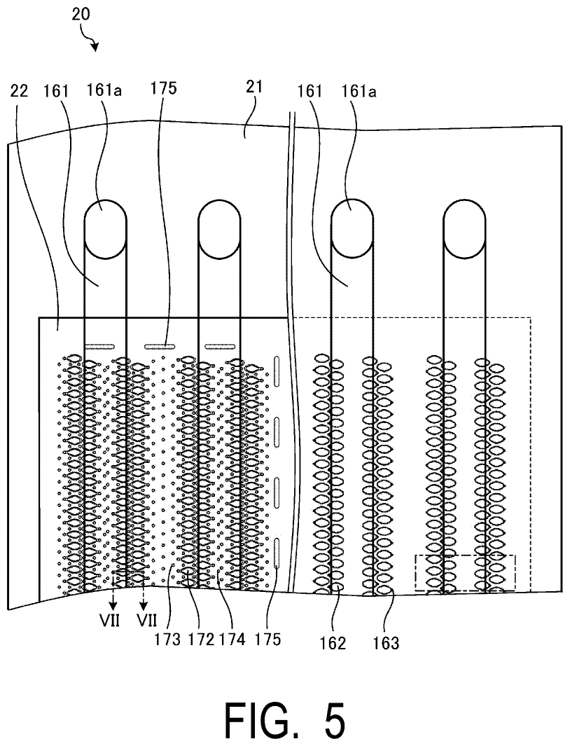

The channel member 21 has a substantially flat plate shape and has a first surface 21a (see FIG. 7) as one main surface and a second surface 21b (see FIG. 7) located on the opposite side of the first surface 21a. The first surface 21a has an opening 161a (see FIG. 5), and the liquid is supplied from the reservoir 70 via the opening 161a into the channel member 21.

A plurality of ejection holes 163 (see FIG. 5) for ejecting the liquid to the printing paper P are located in the second surface 21b. A flow path is formed in the channel member 21 to flow the liquid from the first surface 21a to the second surface 21b.

The piezoelectric actuator substrate 22 is located on the first surface 21a of the channel member 21. The piezoelectric actuator substrate 22 includes a plurality of displacement elements 170 (see FIG. 7). The displacement element 170 is an example of a pressurizing portion. The displacement element 170 is located on the first surface 21a of the channel member 21. The piezoelectric actuator substrate 22 will be described below with reference to FIG. 7.

Flexible substrates 41 and 42 are electrically connected to the piezoelectric actuator substrate 22. The flexible substrates 41 and 42 are flexible wiring boards and have a function of transmitting a predetermined signal sent from the outside to the head body 20. As illustrated in FIG. 3, the liquid ejection head 8 according to an embodiment includes two flexible substrates 41 and 42. FIG. 4 does not illustrate the flexible substrates 41 and 42.

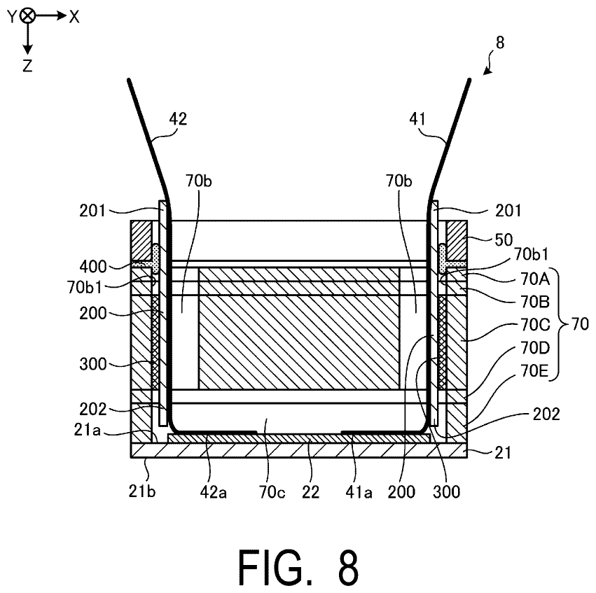

One end portions 41a and 42a (see FIG. 8) of the flexible substrates 41 and 42 are located on the piezoelectric actuator substrate 22 of the head body 20, respectively. The one end portions 41a and 42a are electrically connected to the piezoelectric actuator substrate 22 of the head body 20. The other end portions of the flexible substrates 41 and 42 are inserted into a slit 70b of the reservoir 70, respectively, and extend above the support member 50 from the slit 70b (see FIG. 8), and are electrically connected to other wiring board (not illustrated). The flexible substrates 41 and 42 have a connecting surface connected to the piezoelectric actuator substrate 22 of the head body 20 and an opposite surface located on the opposite side of the connecting surface.

The drive ICs 43 are mounted on the flexible substrates 41 and 42, respectively. The drive IC 43 controls the drive of each displacement element 170 in the piezoelectric actuator substrate 22.

As illustrated in FIG. 3, two drive ICs 43 are provided on each of the flexible substrates 41 and 42. The number of the drive ICs 43 provided on each of the flexible substrates 41 and 42 is not limited to two.

The support member 50 is located on the reservoir 70 and supports a member other than the members illustrated in FIGS. 3 and 4, such as a casing for accommodating the wiring portion 40. The support member 50 has a rectangular frame shape extending in the longitudinal direction of the liquid ejection head 8, and is located on the reservoir 70 so as to surround a predetermined region including the slit 70b in plan view.

The reservoir 70 is located on the first surface 21a side of the head body 20 and is in contact with the first surface 21a other than the piezoelectric actuator substrate 22. The reservoir 70 has a flow path inside, and liquid is supplied from the outside via an opening 70a. The reservoir 70 has a function of supplying a liquid to the channel member 21 and a function of storing the supplied liquid.

The liquid ejection head 8 may further include a member other than those illustrated in FIGS. 3 and 4, such as a casing for accommodating the wiring portion 40.

### Configuration of Head Body

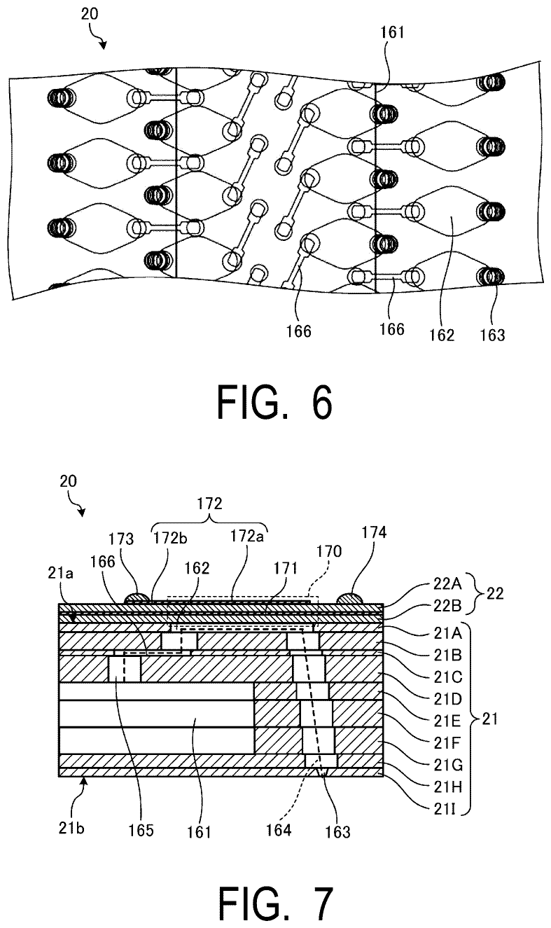

Next, the configuration of the head body 20 according to an embodiment will be described with reference to FIGS. 5 to 7. FIG. 5 is an enlarged plan view of the head body 20 according to an embodiment. FIG. 6 is an enlarged view of a region surrounded by the dashed line illustrated in FIG. 5. FIG. 7 is a cross-sectional view along the VII-VII line illustrated in FIG. 5. In FIG. 5, the right side region is illustrated as a transparent region.

As illustrated in FIG. 5, the head body 20 includes the channel member 21 and the piezoelectric actuator substrate 22. The channel member 21 includes a supply manifold 161, a plurality of pressurizing chambers 162, and a plurality of ejection holes 163.

The plurality of pressurizing chambers 162 are connected to the supply manifold 161. The plurality of ejection holes 163 are respectively connected to the plurality of the pressurizing chambers 162.

The pressurizing chambers 162 are opened to the first surface 21a (see FIG. 7) of the channel member 21. The first surface 21a of the channel member 21 has the opening 161a connected to the supply manifold 161. Then, liquid is supplied from the reservoir 70 (see FIG. 3) to the inside of the channel member 21 via the openings 70a.

In the example illustrated in FIG. 5, the head body 20 includes four supply manifolds 161 inside the channel member 21. The supply manifold 161 has a long thin shape extending along the longitudinal direction of the channel member 21, and at each of both ends, the opening 161a of the supply manifold 161 is formed on the first surface 21a of the channel member 21.

In the channel member 21, a plurality of pressurizing chambers 162 are formed extending two-dimensionally. A pressurizing chamber 162 is a hollow region having a substantially diamond-shaped planar shape with rounded corners. The pressurizing chamber 162 opens on the first surface 21a of the channel member 21, and is closed by joining the piezoelectric actuator substrate 22 to the first surface 21a.

The pressurizing chambers 162 constitute pressurizing chamber row arranged longitudinally. The pressurizing chambers 162 of each pressurizing chamber row is arranged staggered between two adjacent pressurizing chamber rows. Two pressurizing chamber rows connected to one supply manifold 161 constitute one pressurizing chamber group. In the example illustrated in FIG. 5, the channel member 21 includes 4 pressurizing chamber groups.

The relative arrangement of the pressurizing chambers 162 within each pressurizing chamber group is the same, and each pressurizing chamber group is slightly shifted in the longitudinal direction from each other.

The ejection hole 163 is disposed so as to avoid the region facing the supply manifold 161 in the channel member 21. That is, when the channel member 21 is viewed through the first surface 21a, the ejection hole 163 does not overlap the supply manifold 161.

Furthermore, when viewed from a plan view, the ejection hole 163 is located so as to fit within the mounting region of the piezoelectric actuator substrate 22. As a group, such ejection holes 163 occupy a region of approximately the same size and shape as the piezoelectric actuator substrate 22.

Droplets are ejected from the ejection hole 163 by displacing the displacement element 170 (see FIG. 7), which is the corresponding pressurizing portion of the piezoelectric actuator substrate 22.

As illustrated in FIG. 7, the channel member 21 has a layered structure of a plurality of plates. These plates are located in order from the first surface 21a side of the channel member 21, a cavity plate 21A, a base plate 21B, an aperture (restriction) plate 21C, a supply plate 21D, manifold plates 21E, 21F, 21G, a cover plate 21H, and a nozzle plate 21I.

The plates that constitute the channel member 21 have many holes. The thickness of each plate is about 10 μm to 300 μm. This allows to increase the accuracy of the hole formation. The plates are layered in alignment so that these holes communicate with each other to constitute an individual channel 164 and the supply manifold 161.

In the channel member 21, the supply manifold 161 and the ejection hole 163 are connected by the individual channel 164. The supply manifold 161 is located on the second surface 21b side inside the channel member 21, and the ejection hole 163 is located on the second surface 21b of the channel member 21.

The individual channel 164 includes the pressurizing chamber 162 and an individual supply channel 165. The pressurizing chamber 162 is located on the first surface 21a of the channel member 21, and the individual supply channel 165 is a channel connecting the supply manifold 161 and the pressurizing chamber 162.

In addition, the individual supply channel 165 includes an aperture 166 which is narrower than other portions. The aperture 166 is narrower than other portions of the individual supply channel 165, so that the channel resistance is high. Thus, when the channel resistance of the aperture 166 is high, the pressure generated in the pressurizing chamber 162 is difficult to escape to the supply manifold 161.

The piezoelectric actuator substrate 22 includes piezoelectric ceramic layers 22A, 22B, a common electrode 171, an individual electrode 172, a connection electrode 173, a dummy connection electrode 174, and a surface electrode 175 (see FIG. 5).

The piezoelectric actuator substrate 22 includes a piezoelectric ceramic layer 22B, the common electrode 171, the piezoelectric ceramic layer 22A, and the individual electrode 172 layered in this order.

Each of the piezoelectric ceramic layers 22A and 22B has a thickness of about 20 μm. Each layer of the piezoelectric ceramic layers 22A and 22B extends over a plurality of pressurizing chambers 162. The piezoelectric ceramic layers 22A and 22B can be used, which is composed of a ferroelectric lead zirconate titanate (PZT)-based ceramic material.

The common electrode 171 is formed in the region between the piezoelectric ceramic layer 22A and the piezoelectric ceramic layer 22B over the entire surface in the plane direction. That is, the common electrode 171 overlaps all the pressurizing chambers 162 in the region facing the piezoelectric actuator substrate 22. The thickness of the common electrode 171 is about 2 um. A metal material such as Ag—Pd-based metal material can be used for the common electrode 171.

The individual electrode 172 includes an individual electrode body 172a and an extraction electrode 172b. The individual electrode body 172a is located on the piezoelectric ceramic layer 22B, in the region facing the pressurizing chamber 162. The individual electrode body 172a is one size smaller than the pressurizing chamber 162 and has a shape almost similar to that of the pressurizing chamber 162.

The extraction electrode 172b extends from the individual electrode body 172a. The connection electrode 173 is located at one end of the extraction electrode 172b, which extends out of the region facing the pressurizing chamber 162. The individual electrode 172 can be used, which is composed of a metal material such as Au base.

The connection electrode 173 is located on the extraction electrode 172b and has a thickness of about 15 μm and is convex. The connection electrodes 173 are electrically connected to electrodes provided on the flexible substrates 41 and 42 (see FIG. 3). As the connection electrode 173, for example, silver-palladium containing glass frit can be used.

The dummy connection electrode 174 is located on the piezoelectric ceramic layer 22A so as not to overlap with the various electrodes such as the individual electrodes 172. The dummy connection electrode 174 connects the piezoelectric actuator substrate 22 and the flexible substrates 41 and 42, enhancing the connection strength.

In addition, the dummy connection electrode 174 equalizes the distribution of the contact positions between the piezoelectric actuator substrate 22 and the flexible substrates 41 and 42, which stabilizes the electrical connection. The dummy connection electrode 174 is preferably formed by the same materials and processes as the connection electrode 173.

The surface electrode 175 is formed on the piezoelectric ceramic layer 22A at a position to avoid the individual electrode 172. The surface electrode 175 is connected to the common electrode 171 through a via hole formed in the piezoelectric ceramic layer 22A.

Thus, the surface electrode 175 is grounded and held at the ground potential. The surface electrode 175 may be preferably formed of the same material and process as the individual electrode 172.

The plurality of individual electrodes 172 are individually electrically connected to the controller 14 (see FIG. 1) via the flexible substrates 41 and 42 and the wiring in order to individually control the potential. When the individual electrode 172 and the common electrode 171 are set to different potentials and an electric field is applied in the polarization direction of the piezoelectric ceramic layer 22A, the portion in the piezoelectric ceramic layer 22A to which the electric field is applied acts as an active portion distorted by the piezoelectric effect.

That is, in the piezoelectric actuator substrate 22, the portion that faces the pressurizing chamber 162, in the individual electrode 172, the piezoelectric ceramic layer 22A and the common electrode 171, functions as the displacement element 170. When the displacement element 170 is unimorphically deformed, the pressurizing chamber 162 is pressed, and the liquid is ejected from the ejection hole 163.

Next, the driving procedure of the liquid ejection head 8 according to an embodiment will be described. First, the individual electrode 172 is set to a higher potential (hereinafter referred to as a high potential) than the common electrode 171 in advance. Then, each time the ejection request is made, the individual electrode 172 is set to the same potential (hereinafter referred to as a low potential) as the common electrode 171, and then set to the high potential again at a predetermined timing.

As a result, at the timing when the individual electrode 172 is set to the low potential, the piezoelectric ceramic layers 22A and 22B return to their original shapes, and the volume of the pressurizing chamber 162 increases from the initial state (where the potentials of both electrodes are different).

At this time, a negative pressure is applied to the pressurizing chamber 162, and the liquid is sucked into the pressurizing chamber 162 from the supply manifold 161 side. Then, at the timing when the individual electrode 172 is set to the high potential again, the piezoelectric ceramic layers 22A and 22B are deformed so as to convex toward the pressurizing chamber 162 side, and the pressure in the pressurizing chamber 162 becomes positive due to the decrease in the volume of the pressurizing chamber 162.

As a result, the pressure applied to the liquid inside the pressurizing chamber 162 increases, and droplets are ejected. In other words, in order to eject the droplets, a driving signal including a pulse based on the high potential is supplied to the individual electrode 172.

The pulse width may be AL (Acoustic Length), which is the length of time for the pressure wave to propagate from the aperture 166 to the ejection hole 163. This can eject droplets with a stronger pressure, because when the inside of the pressurizing chamber 162 is reversed from the negative pressure state to the positive pressure state, so that both pressures are combined to eject the droplets with stronger pressure.

In the gradation printing, the gradation expression is performed by the number of droplets continuously ejected from the ejection hole 163, that is, the amount of droplets (volume) adjusted by the number of times of droplet ejection. Thus, the number of times of droplet ejection corresponding to the designated gradation expression is continuously performed from the ejection holes 163 corresponding to the designated dot region.

In general, when liquid ejection is performed continuously, the interval between the pulses supplied to eject droplets may be AL. Thus, the period between the residual pressure wave of the pressure generated when ejecting the droplets ejected earlier and the pressure wave of the pressure generated when ejecting the droplets ejected later coincide. This can amplify the pressure for ejecting the droplets due to overlapping of the residual pressure wave and the pressure wave. In this case, the velocity of the droplets ejected later increases, and the impact points of the plurality of droplets become close.

### Configuration of Main Portion of Liquid Ejection Head

Next, the configuration of the main portion of the liquid ejection head 8 according to an embodiment will be described with reference to FIG. 8. FIG. 8 is an enlarged cross-sectional view along the line VIII-VIII illustrated in FIG. 4.

As illustrated in FIG. 8, the reservoir 70 is located on the first surface 21a of the channel member 21, and includes an accommodating portion 70c and the slit 70b.

As described above, the piezoelectric actuator substrate 22 and the respective one end portions 41a and 42a of the flexible substrates 41 and 42 are located in order on the first surface 21a of the channel member 21. The accommodating portion 70c is a space that accommodates the piezoelectric actuator substrate 22 and the respective one end portions 41a and 42a of the flexible substrates 41 and 42 between the accommodating portion 70c and the first surface 21a.

The slit 70b is a groove-like gap extending along the longitudinal direction (Y-axis direction) of the reservoir 70. The slit 70b opens on the upper surface of the reservoir 70, and communicates between the outside of the reservoir 70 and the accommodating portion 70c, which is a space formed inside the reservoir 70. The flexible substrates 41 and 42 connected to the piezoelectric actuator substrate 22 are inserted through the slit 70b, and extend from the slit 70b to the outside of the reservoir 70.

The reservoir 70 includes a protective sheet 200 on one inner wall surface 70b1 facing each flexible substrate 41 and 42 in the width direction of the slit 70b. The inner wall surface 70b1 of the slit 70b is located outside the lateral direction (X-axis direction) of the reservoir 70, and faces the connecting surface of each flexible substrate 41 and 42 inserted through the slit 70b. That is, the slit 70b includes an inner wall surface located inside the lateral direction (X-axis direction) of the reservoir 70, and an inner wall surface 70b1 located outside the lateral direction (X-axis direction) of the reservoir 70. The protective sheet 200 is located between the inner wall surface 70b1 outside the slit 70b and the flexible substrate 41, and between the inner wall surface 70b1 outside the slit 70b and the flexible substrate 42.

As described above, the reservoir 70 includes the protective sheet 200 at the inner wall surface 70b1 of the slit 70b, so that contact between the inner wall surface 70b1 and the flexible substrates 41 and 42 inserted through the slit 70b can be avoided. Thus, the risk of breakage of the flexible substrates 41 and 42 can be reduced.

For example, polyethylene terephthalate or polycarbonate, or the like can be used as the material of the protective sheet 200. The protective sheet 200 is more rigid than the flexible substrates 41 and 42. The higher rigidity of the protective sheet 200 enables the protective sheet 200 to play the role of a guide for guiding the flexible substrates 41 and 42 inserted into the slit 70b, which improves the work efficiency.

The protective sheet 200 has a first surface and a second surface having a surface roughness larger than the first surface. For example, the ten-point average surface roughness (Rz) of the first surface of the protective sheet 200 is about 5 μm, and the ten-point average surface roughness (Rz) of the second surface of the protective sheet 200 is about 15 μm. The second surface of the protective sheet 200 having a large surface roughness is directed toward the flexible substrates 41 and 42. By directing the second surface of the protective sheet 200 toward the flexible substrates 41 and 42, the contact region between the protective sheet 200 and the flexible substrates 41 and 42 is reduced, and the drawing of the flexible substrates 41 and 42 out from the slit 70b can be facilitated. Such a protective sheet 200 may be formed by layering protective sheets having the above-described surface roughness, and is formed by surface processing so as to have the above-described surface roughness.

The protective sheet 200 is bonded to the inner wall surface 70b1 of the slit 70b via a bonding member 300. The bonding member 300 is, for example, double-sided tape. By bonding the protective sheet 200 and the inner wall surface 70b1 of the slit 70b, the position of the protective sheet 200 can be fixed to the inner wall surface 70b1 of the slit 70b. The lower end of the protective sheet 200 has a gap with the piezoelectric actuator substrate 22.

Thus, the lower end of the protective sheet 200 is less likely to contact the piezoelectric actuator substrate 22, making the piezoelectric actuator substrate 22 less likely to be damaged.

As illustrated in FIG. 8, the reservoir 70 has a layered structure of a plurality of plates. The plurality of plates include, for example, plates 70A to 70E, which are located in order from the upper surface side of the reservoir 70. The plates 70A to 70E constituting the reservoir 70 have many holes. The plates 70A to 70E are aligned and layered such that the holes communicate with each other to form the accommodating portion 70c and the slit 70b. For example, the slit 70b is formed by communicating the holes of the plates 70A to 70C with each other, and the accommodating portion 70c is formed by communicating the holes of the plates 70D and 70E with each other. The protective sheet 200 is bonded to the inner wall surface 70b1 in the hole of at least the thickest plate among the plates 70A to 70C via the bonding member 300. In the example of FIG. 8, the plate 70C is the thickest among the plates 70A to 70C, so that the protective sheet 200 is bonded to the inner wall surface 70b1 in the hole of the plate 70C via the bonding member 300. By bonding the protective sheet 200 to the inner wall surface 70b1 in the hole of at least the thickest plate, adhesive strength between the protective sheet 200 and the inner wall surface 70b1 of the slit 70b can be maintained. In addition to the inner wall surface 70b1 in the hole of the plate 70C, the protective sheet 200 may be bonded to the inner wall surface 70b1 in the hole of the plate 70B or plate 70D adjacent to the plate 70C via the bonding member 300.

In addition, the protective sheet 200 has a protruding portion 201 protruding above the upper end portion of the support member 50 from the slit 70b. Thus, the protective sheet 200 can play the role of a guide for guiding the placement of the support member 50 on the reservoir 70, and can accurately position the support member 50 on the reservoir 70. In addition, the protective sheet 200 can serve as a wall to shield the slit 70b from the interface between the reservoir 70 and the support member 50. This reduces the risk that an adhesive 400 described below, which bonds the reservoir 70 and the support member 50, enters the slit 70b.

In addition, the protective sheet 200 is in contact with the flexible substrates 41 and 42, which extends above the upper end portion of the support member 50 from the slit 70b, at the protruding portion 201. Thus, contact between the upper end portion of the support member 50 and the flexible substrates 41 and 42, which extend above the upper end portion of the support member 50, can be avoided, further reducing the risk of breakage of the flexible substrates 41 and 42.

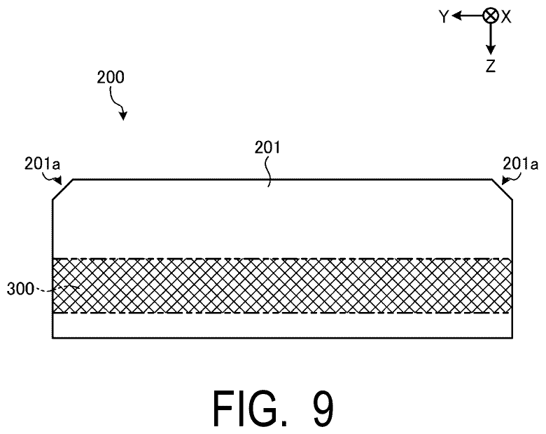

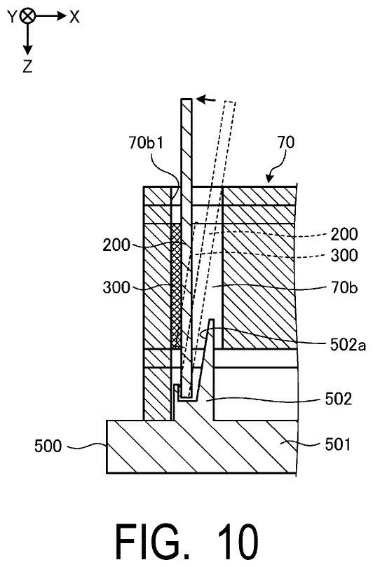

As illustrated in FIG. 9, the protective sheet 200 has chamfered portions 201a at the corners of the protruding portion 201. FIG. 9 is a side view of the protective sheet 200 viewed from the negative X-axis direction. Because the protective sheet has chamfered portions 201a at the corners of the protruding portion 201, interference between the protective sheet 200 and the support member 50 when the support member 50 is positioned on the reservoir 70 using the protective sheet 200 as a guide can be reduced, which improves work efficiency.

The description returns to FIG. 8. The protective sheet 200 has an end portion 202 that is not bonded to the inner wall surface 70b1 of the slit 70b. Such an end portion 202 is located close to the connecting portion (i.e., respective one end portions 41a, 42a of the flexible substrates 41,42) between each of the flexible substrates 41,42 and the piezoelectric actuator substrate 22. This can position the end portion 202 of the protective sheet 200, whose movement is not restricted, near the connecting portion between each flexible substrate 41,42 and the piezoelectric actuator substrate 22, facilitating the drawing of each flexible substrate 41,42 out from the slit 70b.

Additionally, as illustrated in FIG. 8, the support member 50 is bonded to the reservoir 70 via the adhesive 400. A portion of the adhesive 400 seeps out from the interface between the support member 50 and the reservoir 70 and is located between the inner wall surface of the support member 50 and the protective sheet 200. By positioning a part of the adhesive 400 between the inner wall surface of the support member 50 and the protective sheet 200, the protective sheet 200 is bonded to the inner wall surface 70b1 of the slit 70b via the bonding member 300 and is bonded to the inner wall surface of the support member 50 via the adhesive 400. This improves the adhesive strength of the protective sheet 200 and can reduce the likelihood of separation between the protective sheet 200 and the inner wall surface 70b1 of the slit 70b.

### Bonding Method of Protective Sheet

Next, a bonding method of the protective sheet 200 will be described with reference to FIG. 10. FIG. 10 is an explanatory view for describing an example of the bonding method of the protective sheet 200.

The bonding method of the protective sheet 200 uses a jig 500. The jig 500 includes a plate-like base 501 and a pedestal 502 that rises from the base 501 and has a tapered surface 502a.

First, the protective sheet 200 is placed on the pedestal 502 with an inclined state along the tapered surface 502a, and is inserted into the slit 70b of the reservoir 70 together with the pedestal 502. In FIG. 10, the protective sheet 200 placed on the pedestal 502 is represented by a dashed line. The bonding member 300 that is a double-sided tape is previously attached to the protective sheet 200.

Then, the protective sheet 200 is rotated on the pedestal 502 in a direction away from the tapered surface 502a, so that the bonding member 300 is attached to the inner wall surface 70b1 of the slit 70b. Thus, the protective sheet 200 is bonded to the inner wall surface 70b1 of the slit 70b via the bonding member 300. Then, the pedestal 502 is pulled out from the slit 70b of the reservoir 70.

### Other Embodiments

In the above-described embodiments, an example has been described in which the protective sheet 200 has the protruding portion 201 protruding above the upper end portion of the support member 50 from the slit 70b, but a configuration in which the protruding portion 201 is omitted may be adopted. That is, the protective sheet 200 may extend from the slit 70b to the upper end portion of the support member 50.

As described above, the liquid ejection head (e.g., liquid ejection head 8) according to an embodiment, includes the channel member (e.g., channel member 21), the pressurizing portion (e.g., displacement element 170), the flexible substrate (e.g., flexible substrate 41,42), and the reservoir (e.g., reservoir 70). The channel member has an ejection hole (e.g., ejection hole 163) for ejecting a liquid. The pressurizing portion is located on the channel member.

The flexible substrate is electrically connected to the pressurizing portion. The reservoir has a slit (e.g., slit 70b) through which the flexible substrate is inserted, and supplies liquid to the channel member. The reservoir has a protective sheet (e.g., protective sheet 200) on one inner wall surface (e.g., inner wall surface 70b1) facing the flexible substrate in the width direction of the slit. This can reduce the risk of breakage of the flexible substrate by the liquid ejection head according to the embodiment.

Furthermore, the liquid ejection head according to an embodiment may further include a support member (e.g., support member 50) with a frame-shape, located on the reservoir so as to surround a predetermined region including the slit in a plan view. The protective sheet may have a protruding portion (e.g., protruding portion 201) protruding from the slit above the upper end portion of the support member. This can accurately perform positioning of the support member on the reservoir by the liquid ejection head according to the embodiment. In addition, the risk can be reduced that the adhesive (e.g., adhesive 400) bonding the reservoir and the support member penetrates into the slit.

In addition, the protective sheet may be in contact with the flexible substrate at the protruding portion, the flexible substrate extending above the upper end portion of the support member from the slit. Thus, the liquid ejection head according to the embodiment can further reduce the risk of breakage of the flexible substrate.

In addition, the protective sheet may have chamfered portions at the corners of the protruding portion. As a result, the liquid ejection head according to the embodiment can improve the workability when placing the support member on the reservoir using the protective sheet as a guide.

Furthermore, the protective sheet may have a first surface and a second surface having a surface roughness greater than the first surface, and the second surface may be directed toward the flexible substrate. Thus, the liquid ejection head according to the embodiment can facilitate the drawing of the flexible substrate out from the slit.

Furthermore, the protective sheet may be more rigid than the flexible substrate. As a result, the liquid ejection head according to the embodiment can improve the workability when inserting the flexible substrate into the slit.

Additionally, the protective sheet may be bonded to the one inner wall surface of the slit via a bonding member (e.g., bonding member 300). As a result, the liquid ejection head according to the embodiment can fix the position of the protective sheet to one inner wall surface of the slit.

In addition, the reservoir may have a layered structure of a plurality of plates (e.g., plates 70A to 70E). The plurality of plates may include one or more plates (e.g., plates 70A to 70C) having a hole forming the slit. The protective sheet may be bonded, via the bonding member, to one inner wall surface of the hole in at least the thickest plate (e.g., plate 70C) among the one or more plates via a bonding member. Thus, the liquid ejection head according to the embodiment can maintain the adhesive strength between the protective sheet and the one inner wall surface of the slit.

The protective sheet may also have an end portion (e.g., end portion 202) not bonded to the one inner wall surface of the slit. The end portion may be located close to a connecting portion between the flexible substrate and the pressurizing portion. Thus, the liquid ejection head according to the embodiment can facilitate the drawing of the flexible substrate out from the slit.

In addition, the support member may be bonded to the reservoir via an adhesive (e.g., adhesive 400). A portion of the adhesive may be located between an inner wall surface of the support member and the protective sheet. As a result, the liquid ejection head according to the embodiment can reduce the likelihood of separation between the protective sheet and the one inner wall surface of the slit.

Further effects and other embodiments can be easily derived by those skilled in the art. Thus, the broader aspects of the present invention are not limited to the specific details and representative embodiments represented and described above. Accordingly, various modifications are possible without departing from the spirit or scope of the general inventive concept as defined by the appended claims and equivalents thereof.

1. A liquid ejection head, comprising:
a channel member having an ejection hole through which a liquid is ejected;
a pressurizing portion located on the channel member;
a flexible substrate electrically connected to the pressurizing portion;
a reservoir comprising a slit through which the flexible substrate is inserted and a flow path configured to supply the liquid to the channel member; and
a protective sheet located between an inner wall surface of the slit and the flexible substrate.

2. The liquid ejection head according to claim 1, further comprising:
a support member with a frame shape located on the reservoir and surrounding a predetermined region comprising the slit in a plan view, wherein
the protective sheet has a protruding portion protruding above an upper end portion of the support member from the slit.

3. The liquid ejection head according to claim 2, wherein
the protective sheet is in contact with the flexible substrate at the protruding portion, the flexible substrate extending above the upper end portion of the support member from the slit.

4. The liquid ejection head according to claim 2, wherein
the protective sheet has a chamfered portion at a corner portion of the protruding portion.

5. The liquid ejection head according to claim 1, wherein
the protective sheet has a first surface and a second surface having a surface roughness greater than the first surface, and the second surface is directed toward the flexible substrate.

6. The liquid ejection head according to claim 1, wherein
the protective sheet is more rigid than the flexible substrate.

7. The liquid ejection head according to claim 1, wherein
the protective sheet is bonded to the inner wall surface of the slit via a bonding member.

8. The liquid ejection head according to claim 7, wherein
the reservoir has a layered structure in which a plurality of plates are layered,
at least one or more of the plurality of plates have a hole forming the slit, and
the protective sheet is bonded, via the bonding member, to the inner wall surface of the hole in at least the thickest plate among the one or more plates.

9. The liquid ejection head according to claim 7, wherein
the protective sheet has an end portion not bonded to the inner wall surface of the slit, and
the end portion is located close to a connecting portion between the flexible substrate and the pressurizing portion.

10. The liquid ejection head according to claim 7,
further comprising a support member with a frame shape located on the reservoir and surrounding a predetermined region comprising the slit in a plan view, wherein
the protective sheet has a protruding portion protruding above an upper end portion of the support member from the slit,
the support member is bonded to the reservoir via an adhesive, and
a portion of the adhesive is located between an inner wall surface of the support member and the protective sheet.

11. The liquid ejection head according to claim 1, further comprising:
a support member with a frame shape located on the reservoir and surrounding a predetermined region comprising the slit in a plan view, wherein
the protective sheet extends from the slit to an upper end portion of the support member.

12. A recording device, comprising:
the liquid ejection head according to claim 1.
